(19) United States
(12) Patent Application Publication
(10) Pub. No.: US 2011/0154455 A1
(43) Pub. Date: Jun. 23, 2011

(54) Security management framework

(76) Inventors: Shiva R. Nanjangudu, Pearland, TX (US); Philip H. Jung, East Brunswick, NJ (US)

(21) Appl. No.: 11/063,098

(22) Filed: Feb. 22, 2005

(51) Int. Cl. H04L 9/32

(52) U.S. Cl. 726/6

(57) ABSTRACT

A framework is provided for securing and managing sensitive credential information required for a software program, such as an application or a script, to access a resource. The centralized framework validates a request for access to a resource received from the software program, retrieves the encrypted credentials associated with the requested resource, decrypts the encrypted credentials, and provides decrypted credentials to the software program for use in accessing the resource.

### FIELD OF THE INVENTION

The present invention relates to a system and method for providing an application/script with access to a protected resource. Specifically, the present invention relates to a secure and central framework that controls and manages sensitive credential information required to access a protected resource.

### BACKGROUND OF THE INVENTION

Applications and scripts are computer-executable programs designed to interact with other computers, computer programs, databases, or systems. Frequently, applications and scripts are used to emulate actions normally performed by a user. For example, a programmer developing a Web site may create application or script files that emulate users interacting with the Web site to test how the Web site will perform under realistic conditions.

Because scripts typically interact with other software, the scripts often require certain credentials, such as usernames and passwords, to access secure portions of the software with which the script is interacting. To allow the script to function smoothly, most conventional systems hard-code the scripts with the usernames, passwords, and other information required to access the data required. However, because hundreds, if not thousands, of scripts are used by any one operating environment, updating the scripts to reflect new usernames, passwords, or other credentials is an extremely cumbersome task that is highly prone to errors. Further, storing sensitive credential information across many scripts poses a major security problem. For instance, if any one script is viewed by an undesired party, the credentials needed to access multiple resources may be misappropriated, resulting in a significant security breach

Frequently, the applications/scripts requesting access to a resource are located in different operating environments. For example, an application/script may be located in a site integration testing (SIT) environment, a user acceptance testing (UAT) environment, or a production (PRD) environment. The operating environment in which the application/script is located may affect the access rights given to the script. Therefore, for security purposes, it is important to determine the environment from which the request is originating, so that the appropriate level of security may be applied.

To achieve environment-specific security rules, many conventional systems hard code the sensitive credential information in the application/script itself, often in plain text. However, this approach not only poses security risks but also makes it very difficult to change or update the information. Further, changes to an environment that includes a large number of applications/scripts and users are prone to errors. As such, not only are the passwords hard-coded in clear text in conventional systems, but such conventional systems require the extra work of rewriting these scripts when a user wants to run the script in a different environment.

Accordingly, there is a need for a more efficient and manageable system for securing sensitive credentials required by an application/script to access a resource.

### SUMMARY OF THE INVENTION

The present invention relates to a method and a system providing a centralized, controlled, and secured framework for storing sensitive credential information required to access computer-accessible resources. The framework is configured to receive a request to access a resource from a software program, such as a software application or a script. The framework validates each resource request, retrieves the necessary credentials, and provides the credentials to a client computer from which the resource originated. The application/script may then use the credentials to access the resource.

According to an embodiment of the current invention, the resource request includes a username and an IP address of the originator of the resource request (i.e., the application/script). Next, the framework determines whether the originator of the resource request is authorized to access the resource. If authorized, the framework identifies an appropriate file associated with the application/script. This file, referred to as a “resource file,” includes the credentials required to access the requested resource, and provides the credentials to the application/script. The framework retrieves the credentials from the resource file and provides them to the application/script for use in accessing the resource.

According to another embodiment of the invention, the security management framework stores the sensitive credentials in encrypted form, and decrypts the credentials prior to providing them to the application/script.

Advantageously, by centralizing the resource files, the credential information may be modified without having to change each application/script. Further, the present invention increases security by removing sensitive credential information from the application/script files and placing it in a centralized, secure location that may be highly protected.

### BRIEF DESCRIPTION OF THE DRAWINGS

The present invention will be more readily understood from the detailed description of the preferred embodiment(s) presented below considered in conjunction with the attached drawings, of which:

FIG. 1 is a schematic diagram of a security management framework, according to an embodiment of the present invention; and

FIG. 2 is a diagram illustrating a process flow, according to an embodiment of the invention.

It is to be understood that the attached drawings are for the purpose of illustrating concepts of the present invention and may not be to scale.

### DETAILED DESCRIPTION OF THE INVENTION

The present invention relates to a method and a system for allowing a computer-executable application or a script to access a protected resource. Applications or scripts suitable for use in the present invention include but are not limited to any computer implementable application or script known in the art, such as, for example, Microsoft® Word, Microsoft® Excel, Microsoft® PowerPoint, Microsoft® Access, and Corel WordPerfect®.

According to a preferred embodiment, a system 1 according to the present invention includes a computer, referred to as a Client Computer 5, running an application or a script, collectively referred to as an Application/Script 10, and a Security Management Framework 20 communicatively connected to the Client Computer 5. The term “computer” is intended to include any data processing device, such as a desktop computer, a laptop computer, a mainframe computer, a personal digital assistant, a server, or any other device able to process data. The term “communicatively connected” is intended to include any type of connection, whether wired or wireless, in which data may be communicated. The term “communicatively connected” is intended to include a connection between devices within a single computer or between devices on separate computers. One having ordinary skill in the art will appreciate that the Application/Script 10 may be a single application/script or several applications/scripts running conjunctively to perform a common task.

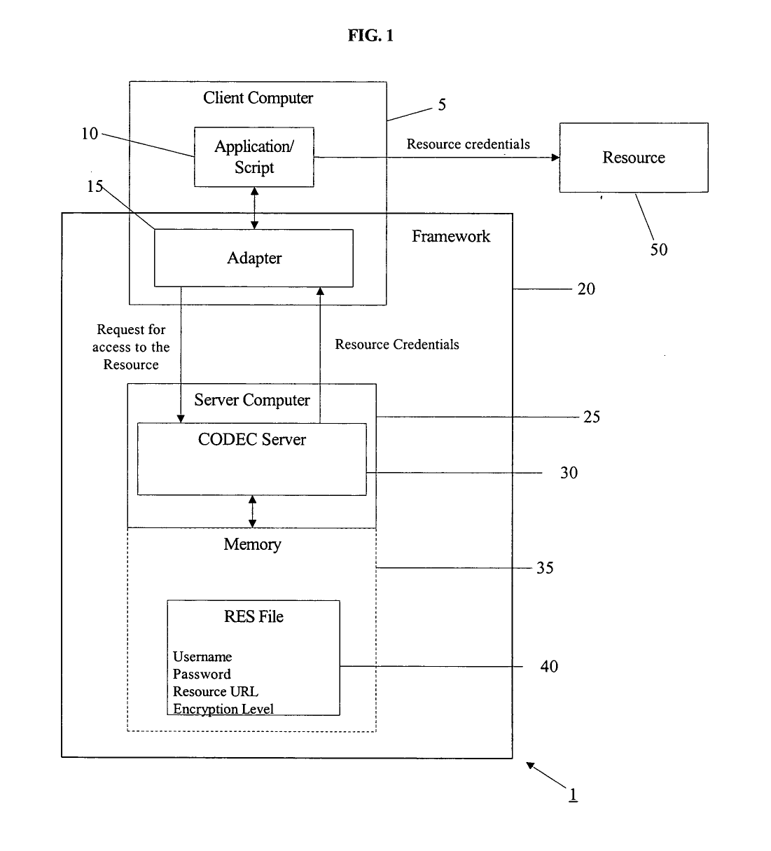

In an embodiment of the present invention, the Application/Script 10 submits to the Security Management Framework 20 a request for access to a Resource 50. The manner in which the present invention provides the Application/Script 10 with the necessary credentials for accessing the Resource 50 is described in detail with respect to FIG. 1.

FIG. 1 illustrates an exemplary Security Management Framework 20 for providing centralized, secured, and controlled storage for sensitive credential information. In a preferred embodiment, the Security Management Framework 20 includes but is not limited to an Adapter 15, a Server Computer 25 including a CODEC Server 30, and a Memory 35. The Adapter 15 receives the request for access to the Resource 50 from the Application/Script 10. As depicted in FIG. 1, the Adapter 15 may reside on the Client Computer 5 and may use known Java utilities to communicate with the Server Computer 25.

In a preferred embodiment, the request includes a username, a password, and an IP address of the Application/Script 10, collectively referred to as the “request information.” The Adapter 15 reviews the request information to determine whether the Application/Script 10 is permitted to access the Resource 50. Specifically, the Adapter 15 validates the resource request if the username and password (“who”), and the IP address (“where”) of the Application/Script 10 are authorized to access the requested resource based on pre-determined access rights. One having ordinary skill in the art will appreciate that any known validation technique may be applied. Further, based on the IP address of the Application/Script 10, the Adapter 15 determines the location of the Application/Script 10, i.e., the environment in which the Application/Script 10 is running.

The Adapter 15 also identifies an appropriate resource file associated with the particular Application/Script 10, referred to as a RES file 40. The RES file 40 includes a list of all the Resources 50 accessible by the Application/Script 10 and assigns a unique name to each of the Resources 50. In addition, the RES file 40 may include, but is not limited to, credentials required to access the one or more Resources 50, referred to as “resource credentials.” The resource credentials may include, but are not limited to, the username and password necessary to access the Resource 50 stored in encrypted form, a list of authorized users of the Resource 50, the URL of the Resource 50, and a type and strength of an encryption level (or algorithm) used to secure the Resource 50. In a preferred embodiment, the RES file 40 further includes the location or environment of the Application/Script 10 and a type of the Application/Script 10 (e.g., Microsoft® Word, Microsoft® Excel, Microsoft® PowerPoint, Microsoft® Access, and Corel WordPerfect®, etc.). One having ordinary skill in the art will appreciate that the RES file 40 may include resource credentials for one or more Resources 50 accessible by the Application/Script 10.

Optionally the request information may include any known signature, depending on the security level associated with the Application/Script 10. For example, the signature may be automatically generated to include a size of the RES file 40 and a creation/modification time of the signature. Using the signature allows for detection of unauthorized tampering with the RES file 40, when the new request for decryption occurs.

Advantageously, the RES file 40 provides a centralized point of access to add/delete/update resource credentials associated with an Application/Script 10. In a preferred arrangement, one or more persons, referred to as Resource Administrators, may be authorized to assign the usernames and passwords and other resource-credential parameters and to create the RES file 40 for each Application/Script 10 for each environment (e.g., SIT, UAT, PRD). Further, the Resource Administrator may establish a single configuration setup to configure the type and strength of the encryption algorithm used, and the required access level for each Application/Script 10 and Resource 50.

This centralized and managed control of the RES file 40 and its contents allows for improved data security and simplified maintenance of the resource credentials in large scale applications over conventional arrangements where sensitive data may be scattered in different configuration files or hard coded in different programming and scripting languages. In addition, the centralized control over the RES file 40 allows for the Resource Administrator to easily implement or change an encryption/decryption scheme specifically for each Application/Script 10. Accordingly, any modification (i.e., change of encryption level, change of password, change of authorized users, etc.) that may effect one or more Client Computers 5 and/or one or more Applications/Scripts 10 may be performed by modifying the RES file 40, thus avoiding the need to modify hard-coded parameters in each individual Application/Script 10.

Advantageously, storing the sensitive resource credentials in the RES file 40 provides for increased data security. First, the resource credentials may be stored in encrypted form in the RES file 40, thereby eliminating any security issues related to storing the credentials in plain text in any form on the system. Furthermore, any number and strength of security provisions may be built around the centralized location storing the sensitive credentials.

Having identified the appropriate RES file 40, the Adapter 15 passes the request and RES file identification information (request information) to the communicatively connected CODEC Server 30. In a preferred embodiment, the CODEC Server 30 is a server program operating on a computer, such as the Server Computer 25.

The CODEC Server 30 is communicatively connected to the Memory 35, which is a computer-readable memory that stores the RES file 40. The term “computer-readable memory” is intended to include any computer-accessible data storage device, whether volatile or nonvolatile, electronic, optical, or otherwise, including but not limited to floppy disks, hard disks, CD-ROMs, DVDs, flash memories, ROMs, and RAMs. One having ordinary skill in the art will appreciate that the Memory 35 may reside on the Server Computer 25 or may be located remotely with respect to the Server Computer 25, the alternative arrangement indicated by the dashed line in FIG. 1.

The CODEC Server 30 accesses the Memory 35 and retrieves the resource credentials from the RES file 40. In a preferred embodiment, the CODEC Server 30 decrypts the encrypted resource credentials and provides the decrypted resource credentials to the Adapter 15, which in turn provides the resource credentials to the Application/Script 10. Any known encryption/decryption technique may be used in accordance with the invention. One having ordinary skill in the art will appreciate that the decryption may be performed on the Client Computer 5, the CODEC Server 30, or any other computer or server communicatively connected to the Client Computer 5 and/or the Security Management Framework 20.

Optionally, depending on the encryption level set for the particular Application/Script 10, the CODEC Server 30 may perform additional security checks. For example, if the request includes a digital signature, the CODEC Server 30 may check the signature to determine if the request is valid.

According to an embodiment of the present invention, the CODEC Server 30 may be configured to perform the decryption process and run at a specific port of the Server Computer 25. When the Application/Script 10 submits a request for decryption, the Adapter 15 may check the relevant port of the Server Computer 25 to determine if the CODEC Server 30 is available. If so, the Adapter 15 routes the decryption request to the CODEC Server 30 for execution. Optionally, the Client Computer 5 may be configured to perform the decryption process itself.

One of ordinary skill in the art will appreciate that although the Adapter 15, the Server Computer 25, the CODEC Server 30, and the Memory 35 are shown in FIG. 1 as physically distinct components, they may be located within a single computer or within different computers communicatively connected over a network. Furthermore, one having ordinary skill in the art will appreciate that the entire Security Management Framework 20 may reside on the Client Computer 5.

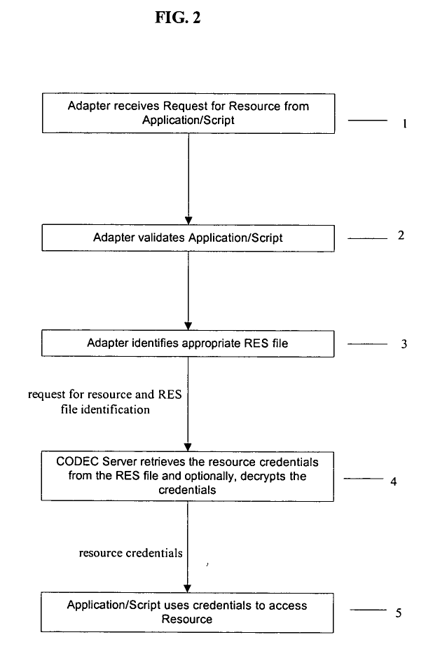

FIG. 2 illustrates an exemplary process flow of a security management method according to an embodiment of the present invention. It is to be understood that the schematic representation provided in FIG. 2 is exemplary in nature and alternative arrangements are within the scope of the present invention.

As illustrated in FIGS. 1 and 2, the Application/Script 10 submits a request for access to a secure Resource 50. The request is submitted with request information that identifies the source of the request. In step 1, the request and the request information are received by the Adapter 15 of the Security Management Framework 20. Optionally, the request further includes a digital signature, known in the art, depending on the level of security associated with the Resource 50 requested.

Based on the username and the IP address corresponding to the request, the Adapter 15 determines whether the Application/Script 10 is authorized to access the requested Resource 50. If the Application/Script 10 is authorized, the Adapter 15 validates the request, in step 2.

In step 3, the Adapter 15 identifies the appropriate RES file 40 associated with the Application/Script 10 submitting the request. Optionally, the RES file 40 is communicatively connected to a database that stores information identifying those individuals authorized as resource administrators (highest level of access; read and write access) and information identifying authorized users (read access only). Each Application/Script 10 may have a specific encryption/decryption scheme associated with its use, and may attach a signature to the request to prevent its use by other applications.

In a preferred embodiment, the Adapter 15 generates RES file identification information and provides the identification information, along with the request, to the communicatively connected CODEC Server 30.

In step 4, using the RES file identification information, the CODEC Server 30 accesses a portion of the Memory 35 storing the appropriate RES file 40. The CODEC Server 30 retrieves the resource credentials stored in the RES file 40. Optionally, the CODEC Server 30 may also retrieve other meta data associated with the Resource 50, such as for example an email address associated with the Resource 50, a number of retry attempts permitted prior to reporting an error, etc. Optionally, the CODEC Server 30 may compare the RES file 40 “signature” (e.g., file size and creation/modification date) provided in the request information with the properties of the RES file 40. This comparison enables the Security Management Framework 20 to detect whether the RES file 40 was tampered with by others.

In a preferred embodiment the resource credentials are stored in the RES file 40 in an encrypted format. According to this embodiment, the CODEC Server 30 decrypts the resource credentials and provides the decrypted resource credentials to the Application/Script 10.

One having ordinary skill in the art will appreciate that the resource credentials may be stored in the RES file 40 in plain text (i.e., in an un-encrypted form) and encrypted by any known encryption program operating on a communicatively connected computer, such as, for example, the Server Computer 25, the CODEC Server 30, or the Client Computer 5.

In step 5, the Application/Script 10 may use the resource credentials to access the Resource 50. Any known Resource 50 may be used in connection with the invention, including but not limited to a database server, an application, a script, a computer, a FTP server, a HTTP address, or any other URL.

### EXAMPLE

The following is an illustrative example of an implementation of the Security Management Framework 20 of the present invention. In this example, an Application/Script 10, called “Remedy_Script,” operates in a user acceptance testing (UAT) environment on a Client Computer 5. The Client Computer 5 running in the UAT environment is communicatively connected to its own database, referred to as “dbUAT,” which stores the usernames and passwords of all the Application/Scripts 10 running in the UAT environment. The Remedy_Script script includes a number of Java programs and shell scripts, known in the art, and seeks access to a database Resource 50 called “RemedyData.” To gain access to the RemedyData resource, the Remedy_Script script retrieves it's username and password (“dbUAT User 1” and “dbUAT password 1”, respectively) from the dbUAT database and provides the request information and request for access to the RemedyData resource to the Security Management Framework 20.

The Remedy_Script script has a RES file 40 associated with it that includes all the Resources 50 accessible to the Remedy_Script, with each Resource 50 having a unique name. In this example, the RemedyData resource has a resource identifier of “RD.”

The Adapter 15 receives and validates the request by confirming that the Remedy_Script script is permitted to access the RemedyData resource. Specifically, the Adapter 15 confirms that a request for the RemedyData resource from dbUAT User 1 using dbUAT password 1 is authorized. If so, the Adapter 15 identifies the appropriate RES file 40 stored in a Memory 35 that includes the resource credentials required by the Remedy_Script to access the RemedyData resource. The Adapter 15 identifies the “RD RES file” and passes this identification information together with the request for access to the CODEC Server 30. Here, the RD RES file includes the following information: the environment of the application/script, the application/script name, the accessible resource names, the encryption level, and the encrypted username and password required to access the resource, as shown in the table below.

TABLE 1
RD RES file

| | | Username | Password | Resource | Encryption |
|---|---|---|---|---|---|
| Environment | Application/Script | (Encrypted) | (Encrypted) | (Name and URL) | Level |
| UAT | Remedy_Script | 4TYH6P | X129VBG | RemedyData | 1 |
| | | | | www.res.com/remedydata | |
| SIT | Remedy_Script | B51VGG | P2RN5@Y | RemedyData | 3 |
| | | | | www.res.com/remedydata | |

The CODEC Server 30 then retrieves the resource credentials from the RD RES file for the Remedy_Script script operating in the UAT environment. In this example, the CODEC Server 30 retrieves the encrypted username “4TYH6P” and encrypted password “X129VBG” and decrypts both using any known decryption technique. The CODEC Server 30 then passes the decrypted resource credentials to the Application/Script 10 for use in accessing the RemedyData resource.

Although the present invention has been described in considerable detail with reference to certain preferred embodiments and version, other versions and embodiments are possible. Therefore, the scope of the present invention is not limited to the description of the versions and embodiments expressly disclosed herein. The references and disclosure provided in the ‘Background of the Invention’ section are not admitted to be prior art with respect to the disclosure provided in the present application.

1. A computer-implemented method for providing access to a resource, the method comprising the steps of:
validating, with an adapter, a request for access to a resource received from a software program located on a client computer based at least on a username, a password, and an IP address included in the request which identifies the software program;
identifying, with the adapter, an environment of the software program;
identifying, with the adapter, a resource file located on a server, wherein the resource file includes encrypted credentials for accessing the resource, and wherein the adapter is remote from the server;
retrieving encrypted credentials from the resource file based at least on the environment of the software program;
decrypting, with the server, the encrypted credentials; and
providing, with the adapter, decrypted credentials to the software program located on a client computer, wherein the software program is configured to use the decrypted credentials to access the resource.

2. (canceled)

3. The computer-implemented method of claim 1, wherein the credentials include a resource username and a resource password.

4. The computer-implemented method of claim 3, wherein the credentials include a URL address of the resource.

5. The computer-implemented method of claim 1, wherein the resource file is stored in a computer-readable memory.

6. The computer-implemented method of claim 1, wherein the resource file includes meta data of the resource.

7. The computer-implemented method of claim 1, wherein the step of identifying the resource file is performed based at least on the environment of the software program.

8. The computer-implemented method of claim 1, wherein the request includes a signature.

9. The computer-implemented method of claim 8, further comprising the step of verifying the signature.

10. The computer-implemented method of claim 1, wherein the resource file includes information related to a plurality of resources.

11. The computer-implemented method of claim 1, wherein the software program is an application or a script.

12. A system for providing access to a resource, the system comprising:
an adapter communicatively connected to a client computer configured to execute a software program, wherein the adapter is configured to:
validate a request for access to a resource received from the software program located on the client computer based at least on a username, a password, and an IP address included in the request which identifies the software program, and
identify an environment of the software program,
identify a resource file stored in a computer-readable memory, wherein the resource file includes encrypted credentials for accessing the resource; and
a server computer communicatively connected to the remotely located adapter, wherein the server computer is configured to:
retrieve the encrypted credentials from the resource file based at least on the environment of the software program,
decrypt the encrypted credentials, and
provide the decrypted credentials to the software program located on the client computer via the adapter, wherein the decrypted credentials allow the software program to access the resource.

13. (canceled)

14. (canceled)

15. (canceled)

16. The system of claim 12, wherein the credentials include a resource username and a resource password.

17. The system of claim 16, wherein the credentials include a URL address of the resource.

18. The system of claim 12, wherein the resource file includes meta data of the resource.

19. The system of claim 12, wherein the adapter is configured to identify the resource file based at least on the environment of the software program.

20. The system of claim 12, wherein the request includes a signature.

21. The system of claim 20, wherein the server computer is configured to verify the signature.

22. The system of claim 12, wherein the server computer includes a CODEC server.

23. The system of claim 12, wherein the software program is an application or a script.

24. (canceled)

25. (canceled)

26. (canceled)

27. (canceled)

28. A computer-readable storage medium storing computer code, wherein the computer code comprises:
code, executable by an adapter, configured for validating a request for access to a resource received from a software program located on a client computer based at least on a username, a password, and an IP address included in the request which identifies the software program;
code, executable by the adapter, for identifying an environment of the software program,
code, executable by the adapter, configured for identifying a resource file, wherein the resource file includes encrypted credentials for accessing the resource;
code, executable by a server, configured for retrieving the encrypted credentials from the resource file based at least on the environment of the software program, and the server is remote from the adapter;
code, executable by the server, configured for decrypting the encrypted credentials; and
code, executable by the adapter, configured for providing decrypted credentials to the software program located on a client computer, wherein the decrypted credentials allow the software program to access the resource.

29. The computer-readable medium of claim 28, wherein the software program is an application or a script.

30. A computer-implemented method for providing access to a resource, the method comprising the steps of:
validating, with an adapter, a request for access to a resource received from a software program located on a client computer based at least on a username, a password, and an IP address included in the request which identifies the software program and a signature;
identifying, with the adapter, an environment of the software program;
identifying, with the adapter, a resource file located on a server based at least on the environment of the software program, wherein the resource file includes encrypted credentials for accessing the resource, wherein the encrypted credentials include a resource username, a resource password, a URL address of the resource, and meta data of the resource, and wherein the adapter is remote from the server;
retrieving, with a server, environment-specific encrypted credentials from the resource file from a computer-readable memory based at least on the environment of the software program;
decrypting, with the server, the encrypted credentials; and
providing, with the adapter, decrypted credentials to the software program located on a client computer, wherein the decrypted credentials allow the software program to access the resource.

31. The computer-implemented method of claim 30, wherein the software program is an application or a script.

32. A system for providing access to a resource, the system comprising:
an adapter communicatively connected to a client computer configured to execute an application or a script, wherein the adapter is configured to:
validate a request for access to a resource received from the application or the script based on a username, a password, and an IP address included in the request which identifies the application or the script and a signature,
identify an environment of the software program;
identify a resource file stored in a computer-readable memory based at least on the environment of the application or the script, wherein the resource file includes encrypted credentials for accessing the resource, wherein the credentials include a resource username, a resource password, a URL address of the resource, and meta data of the resource; and
a server computer communicatively connected to the remotely located adapter, wherein the server computer is configured to:
retrieve the encrypted credentials from the resource file based at least on the environment of the application or script;
decrypt the encrypted credentials; and
provide the decrypted credentials to the application or the script, wherein the decrypted credentials allow the application or the script to access the resource.
